(19) United States
(12) Patent Application Publication
(10) Pub. No.: US 2023/0284609 A1
(43) Pub. Date: Sep. 14, 2023

(54) ASSEMBLY AND METHOD FOR EXTERMINATING PLANTS OR WEEDS, IN PARTICULAR INVASIVE PLANTS OR WEEDS, MORE IN PARTICULAR JAPANESE KNOTWEED

(71) Applicant: TIBACH B.V., Gendringen (NL)

(72) Inventors: Antonius Reinerus Maria EVERS, Gendringen (NL); Niek EVERS, Gendringen (NL); Patrick BEIJERS, Gendringen (NL); Guido KRIEGER, Gendringen (NL); Jan Hendrik Bernardus HOFTIJZER, Gendringen (NL); Joël HESSELINK, Gendringen (NL)

(73) Assignee: TIBACH B.V., Gendringen (NL)

(21) Appl. No.: 18/006,644

(22) PCT Filed: Jul. 23, 2021
(86) PCT No.: PCT/NL2021/050472

§ 371 Date: Jan. 24, 2023

(30) Foreign Application Priority Data
Jul. 24, 2020 (NL) 2026136
Apr. 2, 2021 (NL) 2027912

(51) Int. Cl. A01M 21/04

(52) U.S. Cl. CPC A01M 21/04

(57) ABSTRACT

An assembly for exterminating a plant or weed, in particular an invasive plant or weed, specifically Japanese Knotweed, comprising a cooling device for cooling a coolant, and a cooling lance, fluidly coupled to said cooling device via at least one flexible conduit, said cooling lance adapted to be inserted into the ground and said flexible conduit allowing said cooling lance to be inserted into said ground at a freely selectable position with respect to said cooling device, said cooling lance further comprising a length of 0.5-2 meters, a tip end for inserting and lowering into the ground, a coupling end opposite said tip and having a coolant inlet and a coolant outlet for said coolant, and a coolant flow path through said cooling lance and coupling said coolant inlet and said coolant outlet and allowing cooling of at least part of said cooling lance.

### FIELD OF THE INVENTION

The invention relates to an assembly, a method, and a cooling lance for exterminating a plant or weed, in particular an invasive plant or weed, specifically Japanese Knotweed, and use of a coolant for exterminating plants or weeds.

### BACKGROUND OF THE INVENTION

WO2010008286 in its abstract describes “ . . . a method of exterminating weed, which method comprises the steps of: providing an extermination chamber having at least one open side, placing the open side over weed to be exterminated; substantially closing off the edge of the open side of the extermination chamber and the ground or soil in which the weed is present; providing a refrigerant in the extermination chamber; keeping the extermination chamber in place for a length of time sufficient to exterminate or kill the respective weed by means of the refrigerant while the exterminator moves forward. The invention further relates to a weed exterminator having at least one extermination chamber having at least one open side”.

WO03035987 in its abstract recites: “Freeze wells may be used to isolate an area for soil remediation. Freeze wells may form a frozen barrier around a treatment area. The frozen barrier may inhibit fluid from entering into the treatment area. The frozen barrier may also inhibit migration of contamination out of the treatment area. The frozen barrier may be used to surround all of the perimeter of the treatment area. A frozen barrier may also be formed above or below a treatment area. Freeze wells may be activated in advance of soil remediation so that a frozen barrier is formed when soil remediation is begun. The soil remediation may be accomplished by any type of soil remediation system, including a thermal soil remediation system. Heaters of a thermal soil remediation system may be placed close to the frozen barrier without the barrier being broken through during remediation.”

U.S. Pat. No. 3,263,439 in its claim 1 recites: “Apparatus for treating vegetation to kill undesirable plant life incapable of survival at low temperatures while leaving frost resistant grasses unharmed, said apparatus comprising: a wheeled carrier having a shroud provided with a ground-engaging skirt; and a refrigeration unit mounted on said carrier and including an evaporator within said shroud disposed to lower the temperature of the ground covered by the shroud when said skirt is in engagement with 4 said ground, whereby to kill the undesirable plant life growing in said ground, said shroud including an insulated, normally generally horizontal platform supporting said unit with said evaporator disposed adjacent the underside of the platform, said unit being provided with a thermostatic control having a temperature sensor disposed beneath said evaporator in spaced relationship thereto and overlying the ground when the latter is engaged by the skirt.”

EP2409566 in its abstract describes: “Method of destroying plants/weeds, especially Japanese Knotweed by freezing the contaminated soil and plants in situ using a cryogen, like nitrogen.”

GB2429059 in its abstract describes: “An apparatus for in situ testing of a soil sample comprises: an elongate body having a hollow core and an open end; an upper barrier or means for forming, in use, an upper barrier, within soil, across said hollow core; means for forming, in use, a lower barrier, within soil, across said hollow core such that a sample zone is defined with the hollow core between said upper and lower barriers; fluid supply means for delivery of a fluid to said sample zone; and fluid exit means for removal of said fluid from said sample zone. The barrier(s) may be formed by a cryogenic material e.g. supercritical liquid carbon dioxide to form a plug of frozen soil.

The use of liquid nitrogen already makes most of the known methods difficult and hazardous to apply.

### SUMMARY OF THE INVENTION

In an aspect of the invention there is provided an alternative to known systems. In a further or alternative aspect, there is provided an assembly of method, which at least partly obviates one or more of above-described drawbacks, and/or which provides an improvement to known systems.

There is provide an assembly for exterminating a plant or weed, in particular an invasive plant or weed, specifically Japanese Knotweed, said assembly comprising:
a cooling device for cooling a coolant, and
a cooling lance, fluidly coupled to said cooling device via at least one flexible conduit, said cooling lance adapted to be inserted into the ground and said flexible conduit allowing said cooling lance to be inserted into said ground at a freely selectable position from said cooling device, said cooling lance further comprising:
a length of 0.5-2 meters;
a tip end for inserting and lowering into the ground
a coupling end opposite said tip and having a coolant inlet and a coolant outlet for said coolant, and
a coolant flow path through said cooling lance and coupling said coolant inlet and said coolant outlet and allowing cooling of at least part of said cooling lance.

The coolant flow path is a flow path for circulating the coolant. The coolant flow path is typically a closed loop or system such that during normal operation no or a minimum of coolant is added to the assembly. This coolant flow path provides the advantage that coolant does not contaminate the environment with coolant. Furthermore, the reuse of coolant increases energy efficiency of the assembly. Furthermore, the reuse of coolant obviates the need for constant refills of the assembly with coolant as well as the assembly may operate for longer periods of time without an operator to be present.

There is further provided a method for exterminating weeds and plants, in particular invasive plants and weeds, specifically Japanese knotweed, comprising:
cooling a coolant to a temperature of below 258K;
inserting a cooling lance with its tip end into ground near a said weed or plant for defining an area to be processed;
circulating said coolant through said cooling lance for attaching an extermination temperature of below 258K, and
maintaining said extermination temperature of said cooling lance for a predefined amount of time, in particular for least 5 days.

There is further provided the use of a coolant that is liquid in at least a temperature range of 173K-260K, in particular in a temperature range of 200K-260K, more in particular in a temperature range of 240K-260K, wherein said coolant is selected from:
water comprising a freezing point-lowering plant-based composition;
a vegetable oil, and
a mixture thereof,
   at a temperature of below a 258K for exterminating weeds and plants, in particular invasive plants and weeds, specifically Japanese knotweed.

Known systems used large amounts of energy. Known systems use coolants that may be harmful and/or may cause personal injuries. Known systems or not suitable to treat small patches of land.

It is known that freezing can kill almost any weed. For instance, lowering the temperature of the ground housing a root system of a Japanese Knotweed plant to below 263K (−10° C.) during some days will in general kill the weed. However, attaining this temperature and maintaining it during a time has proven difficult. Furthermore, further ground/soil life is to be spared as much as possible. And a risk of contamination in case of problems like leakage is to be minimized. The current invention allows solving this problem.

In an embodiment the at least one flexible conduit comprises a flexible supply conduit and a flexible retour conduit, said flexible supply conduit coupled to said coolant inlet of said cooling lance, and said flexible retour conduit coupled to said coolant outlet of said cooling lance.

In an embodiment the cooling lance comprises a substantially tubular outer mantle ending at one end in said tip end suitable for driving said cooling lance into ground, an inner tube having one end coupled to a flexible conduit and its opposite end extending within said outer mantle to said tip end of said outer mantle.

In an embodiment the assembly comprises a series of said cooling lances, each cooling lance coupled to said cooling device via said at least one flexible conduit allowing each cooling lance to be positioned individually into the ground. In particular, each of said cooling lances comprising at least one flexible conduit.

In an embodiment each of said cooling lances comprising a said flexible conduit. In particular, said cooling lances are fluidly coupled in parallel to said cooling device. Each cooling lance comprising a flexible inlet conduit fluidly coupled to a cooling device outlet and a flexible outlet conduit fluidly coupled to a cooling device inlet.

In an embodiment the assembly further comprising a reservoir for coolant, fluidly coupled to said cooling device.

In an embodiment the assembly further comprising a temperature lance for inserting into the ground, said temperature lance comprising at least one temperature sensor.

In an embodiment the assembly further comprising a controller, at least one temperature sensor functionally coupled to said controller, and said cooling device functionally coupled to said controller, wherein said controller is adapted for in operation operating said cooling device to a set temperature of said temperature sensor.

In particular the controller is functionally coupled to at least one temperature lance described above.

In an embodiment the controller comprises a data processor and a computer program comprising a non-transitory computer readable medium, wherein when running om said data processor, receives temperature data from said at least one temperature sensor, compares said temperature data with set temperature data for said temperature sensor, and controls a flow rate of said coolant through said cooling lance for reaching and maintaining said set temperature.

In an embodiment the assembly further comprising an insulation box comprising a box wall and a box lid, said box wall providing a closed wall enclosing in use a processing area including said at least one cooling lance, and said box lid resting on said box wall.

In the assembly and method, a coolant is used. In an embodiment the coolant is liquid in at least a temperature range of 173K-260K. In particular, the coolant is liquid in a temperature range of 200K-260K. More in particular, the coolant is liquid in a temperature range of 240K-260K. In an embodiment, the coolant has a viscosity at a temperature of 243K (−30° C.) is 20 mm²/sec+/−20%. In particular, the viscosity is 20 mm²/sec+/−5%. For instance, a product called ZeroTox Plus from InnoGreen can be used at a mixture rate of 60% V/V with water.

In an embodiment the coolant is selected from:
water comprising a freezing point-lowering plant-based composition;
a vegetable oil, and
a mixture thereof.

In an embodiment the freezing point lowering plant-based composition is selected from saccharide, protein, fatty acids, and a mixture thereof. In particular the saccharide is selected from sugar, starch and a mixture thereof. More in particular, the plant-based composition is derived from corn, potato, sugar cane, sugar beet, fruit. In an embodiment, processing waste from plant material can be used.

In particular, saccharide is a group that includes sugars, starch, and cellulose. The saccharides can be divided into four chemical groups: monosaccharides, disaccharides, oligosaccharides, and polysaccharides. Monosaccharides and disaccharides, the smallest (with lower molecular weight) carbohydrates, are commonly referred to as sugars. Monosaccharides are fructose (fruit sugar) and glucose (starch sugar), disaccharides are sucrose (cane or beet sugar) and lactose (milk sugar). They are found in a wide variety of natural and processed foods.

Starch is a polysaccharide. It is abundant in cereals (wheat, maize, rice), potatoes, and processed food based on cereal flour, such as bread, pizza or pasta. Sucrose is generally extracted from sugarcane or sugar beets. Lactose (for instance abundant in milk), glucose and fructose, occur naturally in honey, many fruits, and some vegetables.

Cellulose, is a polysaccharide found in the cell walls of all plants. Other polysaccharides include resistant starch and inulin. Short-chain fatty acids may also be included.

In an embodiment, the vegetable oil or triglycerides extracted from plants is selected from sunflower oil, rapeseed oil, safflower oil, soybean oil, palm oil, cottonseed oil, coconut oil.

In an embodiment, the method uses the assembly describe above.

In an embodiment the method comprises:
cooling said coolant to a temperature of below 258K;
inserting a said cooling lance with its tip end into ground near a said weed or plant for defining an area to be processed;
circulating said coolant through said cooling lance for attaching an extermination temperature of below 258K, and
maintaining said extermination temperature of said cooling lance for a predefined amount of time, in particular for least 5 days.

In an embodiment the method further comprises:
placing a box wall for enclosing an area to be processed, and
applying a box lid on said box wall.

In an embodiment the method comprises:
providing a temperature sensor, in particular a temperature lance, at a predefined distance of said cooling lance, and circulating said coolant until said temperature sensor indicates a set temperature for said temperature sensor for a predefined amount of time.

In an embodiment the use of the coolant in in the above-described method.

There is further provide an assembly for exterminating or controlling a plant or weed, in particular an invasive plant or weed, specifically Japanese Knotweed, said assembly comprising:
a cooling device for cooling a coolant, and
a cooling lance fluidly coupled to said cooling device, said cooling lance adapted to be inserted into the ground, said cooling lance further comprising:
a tip end for inserting and lowering into the ground
a coupling end opposite said tip and having a coolant inlet and a coolant outlet for said coolant, and
a coolant flow path coupling said coolant inlet and said coolant outlet and allowing cooling of at least part of said cooling lance.

The term “substantially” herein, such as in “substantially all emission” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

The term “functionally” will be understood by, and be clear to, a person skilled in the art. The term “substantially” as well as “functionally” may also include embodiments with “entirely”, “completely”, “all”, etc. Hence, in embodiments the adjective functionally may also be removed. When used, for instance in “functionally parallel”, a skilled person will understand that the adjective “functionally” includes the term substantially as explained above. Functionally in particular is to be understood to include a configuration of features that allows these features to function as if the adjective “functionally” was not present. The term “functionally” is intended to cover variations in the feature to which it refers, and which variations are such that in the functional use of the feature, possibly in combination with other features it relates to in the invention, that combination of features is able to operate or function. For instance, if an antenna is functionally coupled or functionally connected to a communication device, received electromagnetic signals that are receives by the antenna can be used by the communication device. The word “functionally” as for instance used in “functionally parallel” is used to cover exactly parallel, but also the embodiments that are covered by the word “substantially” explained above. For instance, “functionally parallel” relates to embodiments that in operation function as if the parts are for instance parallel. This covers embodiments for which it is clear to a skilled person that it operates within its intended field of use as if it were parallel.

Furthermore, the terms first, second, third and the like in the description and in the claims, are used for distinguishing between similar elements and not necessarily for describing a sequential or chronological order. In particular, for instance reference can be made to first, second and third lance. It is to be understood that the terms so used are interchangeable under appropriate circumstances and that the embodiments of the invention described herein are capable of operation in other sequences than described or illustrated herein.

The devices or apparatus herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device or apparatus claims enumerating several means, several of these means may be embodied by one and the same item of hardware. The mere fact that certain measures are recited in mutually different dependent claims does not indicate that a combination of these measures cannot be used to advantage.

The invention further applies to an apparatus or device comprising one or more of the characterising features described in the description and/or shown in the attached drawings. The invention further pertains to a method or process comprising one or more of the characterising features described in the description and/or shown in the attached drawings.

The various aspects discussed in this patent can be combined in order to provide additional advantages. Furthermore, some of the features can form the basis for one or more divisional applications.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts an embodiment of the assembly;

FIGS. 2A-2E schematically depict various aspects and view of a cooling lance;

FIGS. 3A-3C schematically shows a box covering cooling lances;

FIG. 4 a removal tripod for a cooling lance;

FIG. 5 a coolant removal assembly;

FIG. 6 a cooling lace with hot air heater;

FIGS. 7 and 8 several views of an alternative embodiment of the cooling lance;

FIG. 9 schematically an other embodiment of the assembly in parallel, and

FIG. 10 schematically an other embodiment of the assembly in series.

The drawings are not necessarily on scale

### DESCRIPTION OF PREFERRED EMBODIMENTS

The process for exterminating or weed control of many weeds needs to be done carefully. Especially with Japanese Knotweed, one needs to work very concise and careful. First, in order to better understand the assembly, the components will be described on the hand of the attached drawings. Next, the general method will be described.

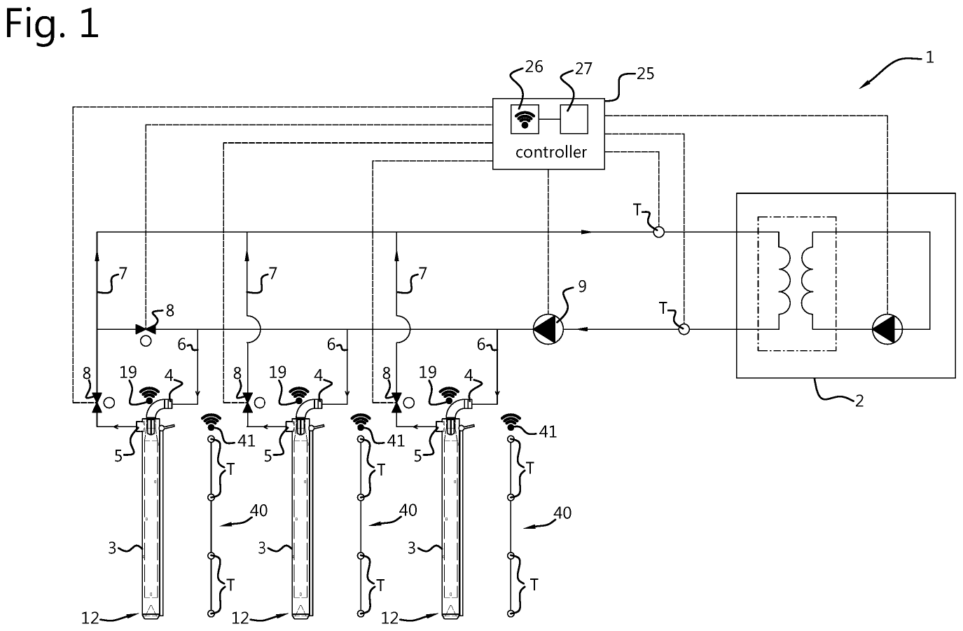

FIG. 1 schematically depicts an assembly 1 for exterminating weeds or for weed control. The assembly 1 comprises a cooling device 2. The assembly further comprises at least one cooling lance 3. In FIG. 1, a number of cooling lances 3 are coupled to the cooling device 2. The at least one cooling lance 3 has a coolant inlet 4 and a coolant outlet 5. The coolant inlet 4 of cooling lance 3 is fluidly coupled to a coolant outlet of the cooling device 2. The coolant outlet 5 of the cooling lance 3 is fluidly coupled to a coolant inlet of the cooling device 2. For coupling, flexible conduits 6, 7 can be used, allowing free positioning of the cooling lance 3 with respect to one another. Care should be give to select conduits 6, 7, like hoses or tubes, that are flexible at the applied coolant temperatures. In fact, the conduits 6, 7 in an embodiment are flexible, in the current case in an embodiment meaning that a conduit can bend, at a temperature down to 263K without breaking or otherwise being damaged. In an embodiment, a conduit is selected that is flexible at a temperature down to 258K. In the embodiment of FIG. 1, the cooling lance 3 has a flexible inlet cooling conduit 6 fluidly coupled to its cooling lance inlet 4 and to the cooling device. The cooling lance 3 further comprises an outlet cooling conduit 7 fluidly coupling the cooling lance outlet 5 and the cooling device inlet.

In the embodiment of FIG. 1, the cooling lances 3 are coupled parallel to the cooling device 2. In this way, a flow though each of the cooling lances 3 can be controlled separately.

In this way, it allows the cooling capacity of each cooling lance 3 to be controlled individually. In order to provide a further control of the operation of a cooling lance 3, it comprises a control valve 8. In the current embodiment, the control valve 8 is operationally coupled to cooling lance outlet 5.

For measuring and checking the temperature and thus effectiveness of the assembly 1 in operation and for allowing monitoring of the effectiveness and operation, the assembly 1 comprises at least one temperature sensor T. In an embodiment, at least one temperature lance 40 is provided. Such a temperature lance is adapted for insertion into the ground. A temperature lance 40 comprises at least one temperature sensor T. In an embodiment, Temperature lance 40 comprises several temperature sensors T at various locations along a length of a temperature lance. This allows measuring a temperature profile in time and in depth in the ground.

In the current assembly 1 of FIG. 1, A temperature sensor T is provided near an inlet of the cooling device 2, and one near an outlet of the cooling device 2. In this way, an energy extraction out of the ground can be determined. In the embodiment of FIG. 1, furthermore a temperature sensor 19 is provided at or on a cooling lance 3. Thus, operation and performance of each cooling lance 3 can be monitored.

In FIG. 1, a specific embodiment of a cooling device 2 is depicted. The cooling device 2 comprises a primary cooling loop with a pump. The cooling device 2 here further comprises a heat exchanger and a coupled secondary cooling circuit of inlet conduits 6, cooling lances 3 and outlet conduits 7. This secondary cooling circuit has a cooling pump 9. In stead of the depicted cooling device, other embodiments of the cooling device may be considered. Here, a thermally coupled primary and secondary circuit are proposed. A skilled person may device other suitable cooling device 2.

The secondary cooling circuit can be short circuited using a valve 8.

The assembly of FIG. 1 further comprises a controller 25. The controller 25 receives input from various sources. The controller may be a (mainly) hardware device like a logical circuit. For more flexibility, however, it may comprise a data processor 27 allowing running of a computer program. The controller may comprise or be a general purpose computer. In an embodiment, the controller 25 further comprises a wireless communication device, or a wireless transceiver. This allows flexible coupling of input, control and measuring devices. For instance, as indicated, temperature sensors provided with a wireless transceiver as indicated. The valves may also comprise a wireless transceiver for allowing wireless coupling to the controller 25. In the embodiment of FIG. 1, the controller is also functionally coupled to the cooling device 2 for controlling and monitoring its operation. In FIG. 1, the controller is functionally coupled to cooling pump 9 and to the primary cooling circuit, here a pump of it. In the embodiment of FIG. 1, a temperature lance 40 comprises a wireless transceiver 41, allowing flexible coupling of a selected number of temperature lances to the controller 25.

The controller 25 is furthermore here functionally coupled to the valves 8. The coupling of FIG. 1 of the controller 1 allows monitoring operation and effectiveness of the assembly 1. When the controller is furthermore provided or coupled with a memory, temperature data can be logged in time, for instance.

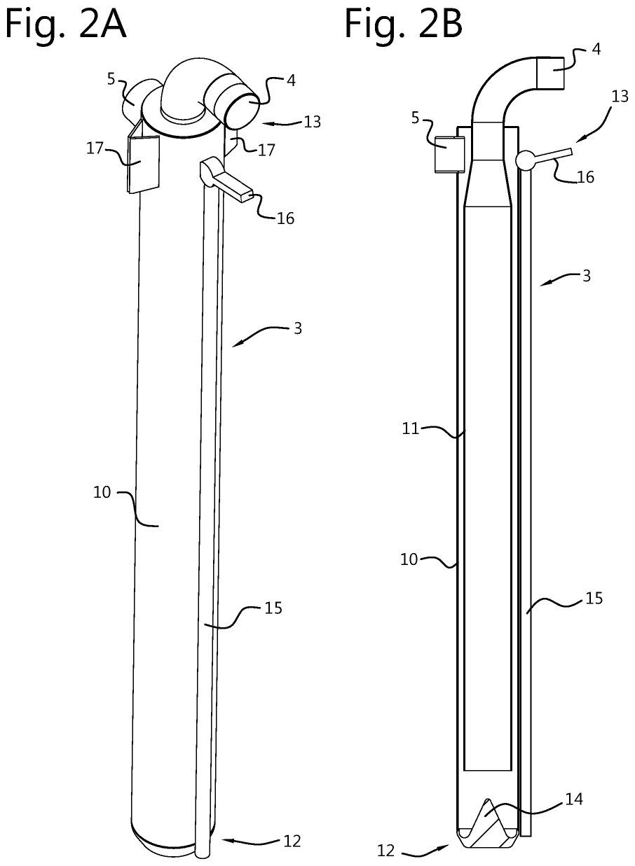

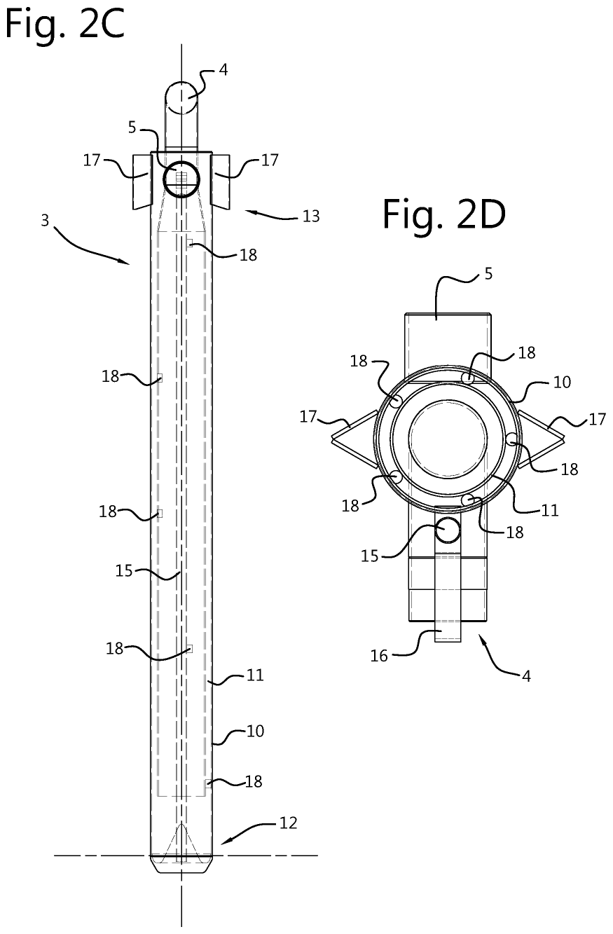

In FIGS. 2A, 2B, 2C and 2D, a cooling lance is depicted in more detail. FIG. 2 shows a 3D view, FIG. 2B a longitudinal cross section, FIG. 2C a view showing the interior in dotted lines, and FIG. 2D showing a top view.

A cooling lance 3 has a tip end 12 that in use is inserted into the ground, and a coupling end 13 that comprises the inlet 4 and outlet 5. In use, the coupling end 13 will stick out of the ground, allowing coupling of conduits 6, 7 after positioning of the cooling lance 3 in the ground. The cooling lance 3 further comprises at the coupling end 13 extraction handles, allowing attachment of an extraction device.

A cooling lance 3 in use is lowered into a hole in the ground and after lowering the possibly remaining hole is filled with for instance sand or dirt and/or water.

The cooling lance 3 comprise a coolant flow path coupling a cooling lance inlet 4 and cooling lance outlet and allowing said coolant to cool at least a length of the cooling lance 3. In to current embodiment, a cooling lance 3 comprises an outer mantle 10, often a metal tube. The cooling lance 3 has a length and a diameter. In most embodiments, a length of less than 3 meters is sufficient. Furthermore, for most practical use, the length is more than 0.5 meter. In general, the cooling lance length will be between 1 and 2 meters. Often, a length of around 1-1.5 is sufficient,

The cooling lance 3 has a diameter of less than 50 cm. Usually, the diameter will be at least 5 cm. For most applications, the diameter will be 7-20 cm. For extermination of Japanese Knotweed and most known weeds, a diameter of between 10-15 cm is sufficient, allowing proper cooling and easy placement.

In the outer mantle 10, an inner tube 11 is provided. In the embodiment depicted, the outer mantle 10 and inner tube 11 are concentric tubes having a circular cross section. The inner tube 10 extends from the coupling end up to a distance from the end of the cooling lance 3. Usually, the inner tube 11 ends between 1 cm and 20 cm above the end. The coupling end of the inner tube is here fluidly coupled to the cooling lance inlet 4 and the cooling lance outlet 5 is provided at or near the coupling end in the outer mantle 10. Spacers 18 here keep the inner tube 11 concentrically in the outer mantle 10. It the embodiment of FIGS. 2, the cooling lance inlet 4 and the cooling lance outlet 5 open in radially opposite directions. This allows easy coupling.

In the embodiment of FIG. 2B, the inner surface of the cooling lance tip 12 in the inside comprises a central cone 14 extending to the coupling end and having its apex aligned with a center line of the inner tube 11. The apex is at a distance from the end of the inner tube, usually 2-10 cm. This provides a more constant flow of coolant in operation. The current inner tube 11 and outer mantle 11 construction of the cooling lance 3 provide an effective cooling of the cooling lance 3 along its length and of its outer surface.

For easier extraction after use, the cooling lance 3 is provided with an aeration tube or pipe 15 extending from the tip end 12 to the coupling end 13. At its coupling ends end, the aeration tube 15 comprises a closure with a lever allowing opening and aeration upon extraction of the cooling lance 3.

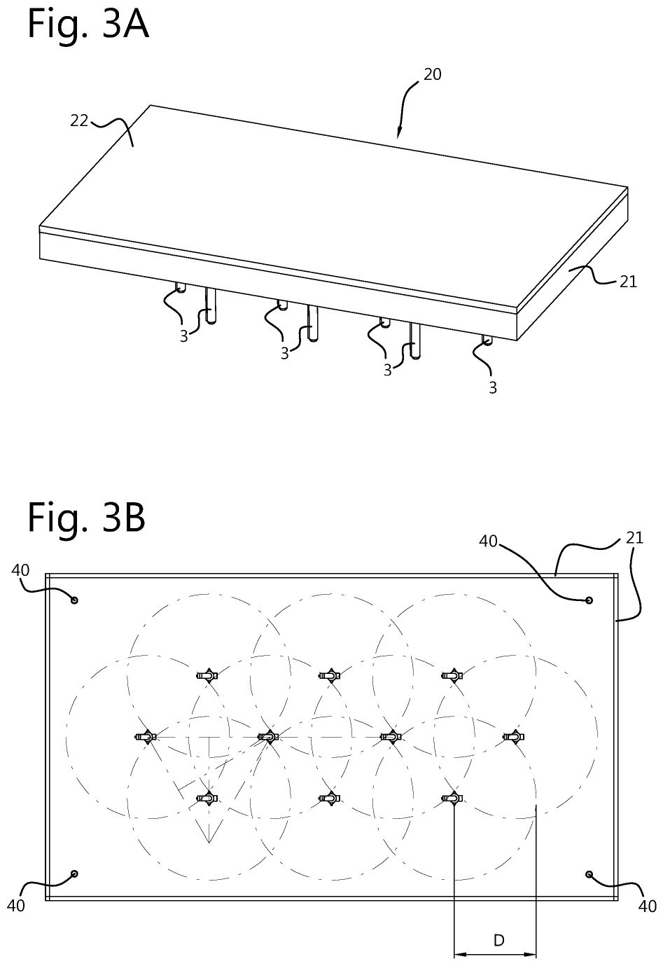

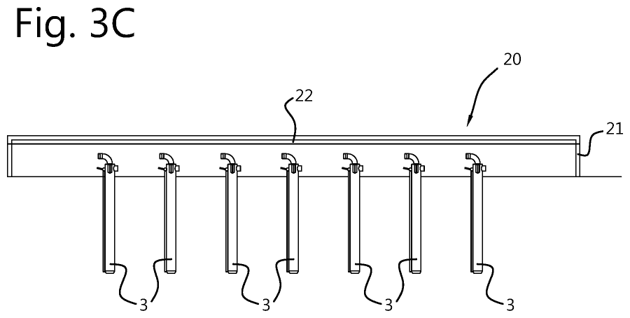

FIGS. 3A-3C shows an insulation box 20. The insulation box 20 in this embodiment is rectangular. other shapes, however, are possible. The insulation box 20 comprises a box wall 20 that defines an enclosed area. In this enclosed area, cooling lances 3 and (indicated in FIG. 3B) temperature lances are placed in the ground. Usually, the box wall 21 has a thermal insulation. Furthermore, the insulation box 20 comprises an insulating box lid 22. The insulating box 20 has several functions. First, it defined an enclosed treatment or processing area. Furthermore, it provides insulation, preventing exterior heating of the area that is being processed. This saves energy and time. Furthermore, it provides a space for treating plant material and material from holes for cooling lances. When a large areal of land has to be treated, one or more assemblies of FIG. 1 can be used, each having its insulation box 20. After treatment, a next patch of land can be treated by moving the insulation box 20. Placing temperature lances 40 near the box wall, for instance near corners of a rectangular box 20, the process can be monitored and validated.

In FIG. 3B, a pattern for placement of cooling lances 3 is illustrated. In this pattern, there is an overlap of working ranges. For instance, the distance D is a predefined working range of a lance, providing a set cooling temperature within a defined amount of time. For instance, in average conditions, a temperature is reached within a day is a daily temperature extension speed. On average, the temperature boundary of 258K can travel 25 cm (radially) in a day. Thus, at such a temperature boundary speed, placing the lances at a working distance of D=1 meter will result in cooling the circled area within two days. In fact, in practise the cooling lances 3 are distances between 0.5-2 meters. When placed closer together, an area may cooled swifter.

In fact, if for instance a strip of land needs to be treated of processed, the cooling lances 3 can be placed in a row. For instance, for treating of the middle of a motorway (separating opposite lanes).

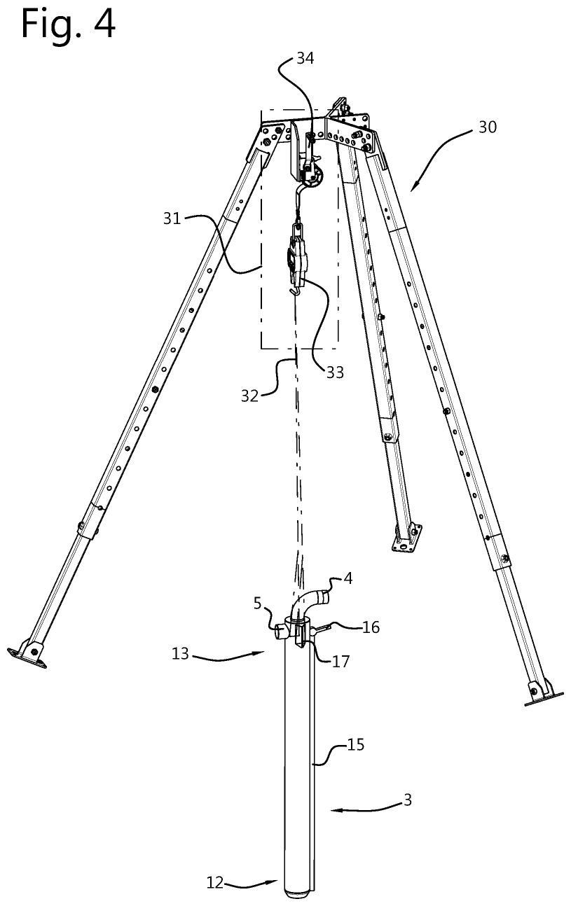

FIG. 4 illustrates an embodiment of an extraction device 30 for extracting or facilitating extraction of extraction of a cooling lance 3 after cooling. In most cases, a cooling lance 3 will be froze into the ground and requires (too) much force to be remove, for instance risking damage. The frame, here a tripod, comprises a pre-tensioning device 31 and an extraction line 32. The pre-tensioning device 31 here comprises a force indicator, for instance a spring balance 33. Furthermore, the tensioning device 31 comprise a force applicator, here a winch 34. When the cooling lance 3 is still frozen into the ground, the extraction device is attached and a pre-tensioning force is applied through the winch 34. Next, heat is applied, for instance by blowing heated air into a cooling lance 3. When the ground thaws or defrosts, the cooling lance 3 will be pulled out by the force applied by the extraction device 30.

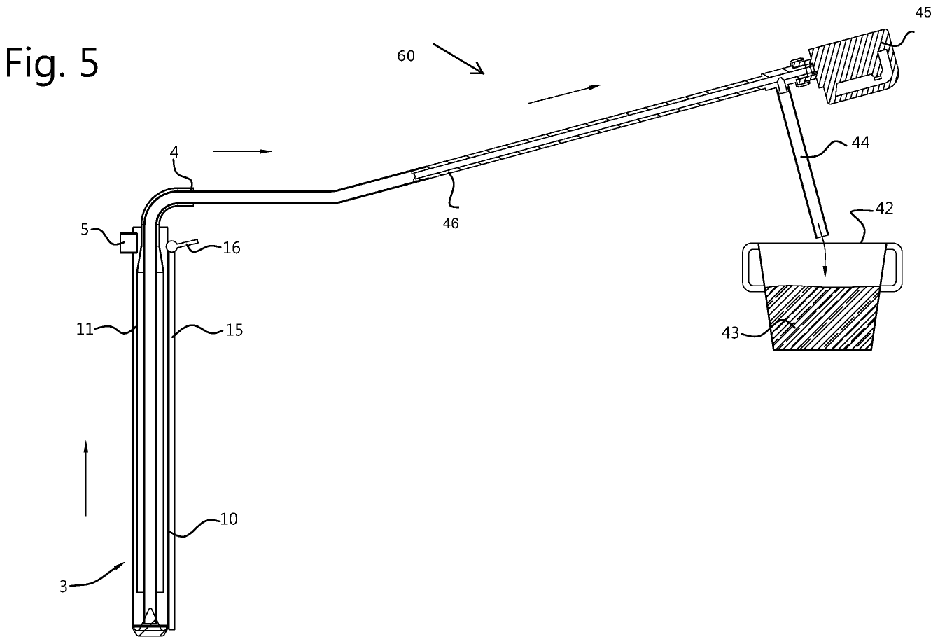

Before the cooling lance 3 is extracted or removed out of the ground, an emptying device can be applied. In FIG. 5, an embodiment of such an emptying device 60 is illustrated. It comprise a conduit or hose 46 coupling to said cooling lance inlet 4 and running to a bottom of said cooling lance 3. It further comprises a pump 45 for providing an under-pressure in said conduit, and a coolant outlet 44. Residual coolant 43 is sucked out of the cooling lance and via the coolant outlet 44 into a container 42, for instance for re-use.

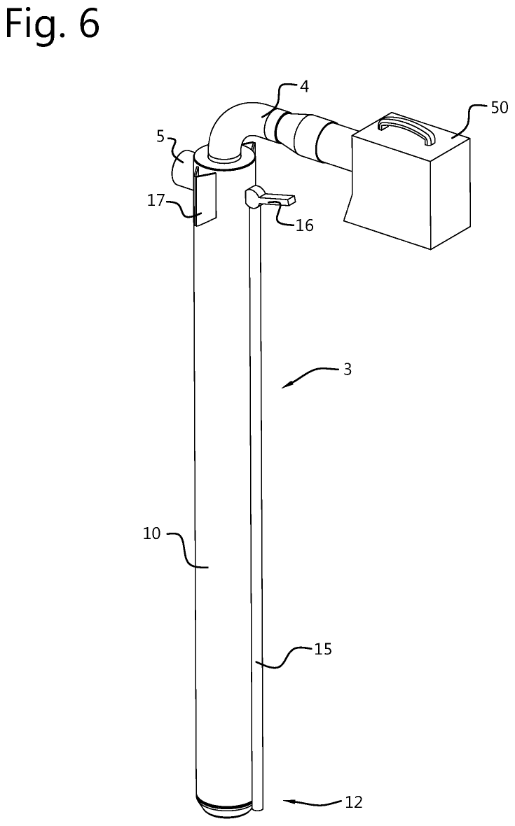

For swift thawing or melting the ground for removing the lances, it is also possible co couple a hot air heater to the cooling lance 3. In FIG. 6, an easy to use embodiment is illustrated. In this embodiment, the coolant inlet 4 of the cooling lance 3 is coupled to a hot air hand blower 50. The coolant inlet 4 comprises a snap coupling or bayonet coupling corresponding to a coupling of the hot air blower. Air of up to 600K or more is blown into a cooling lance 3 and allows swifter removal.

The controller 25 as mentioned above can be a general purpose computer, computer system, distributed computer, or for instance a PLC.

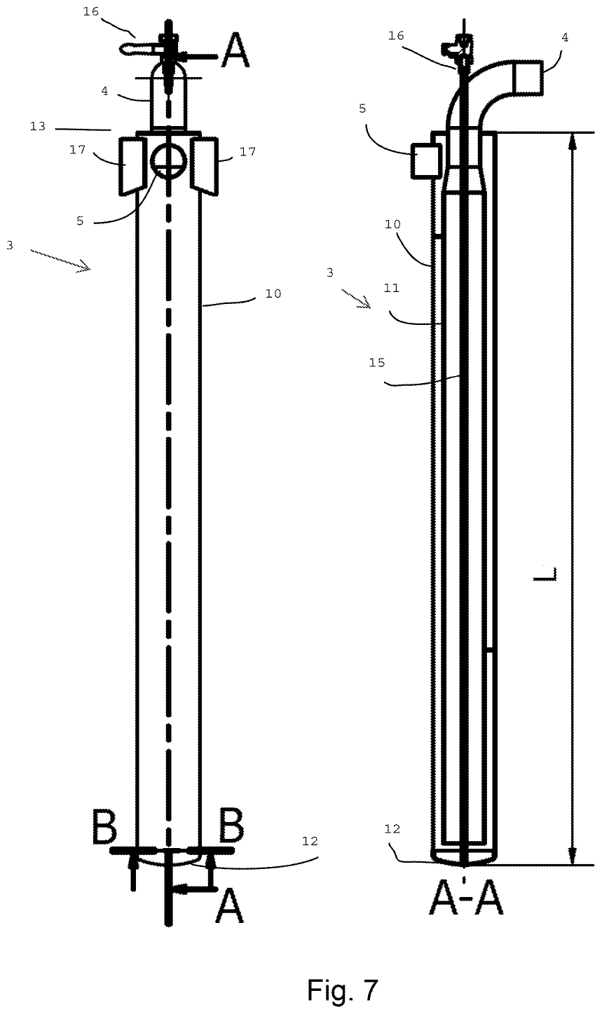

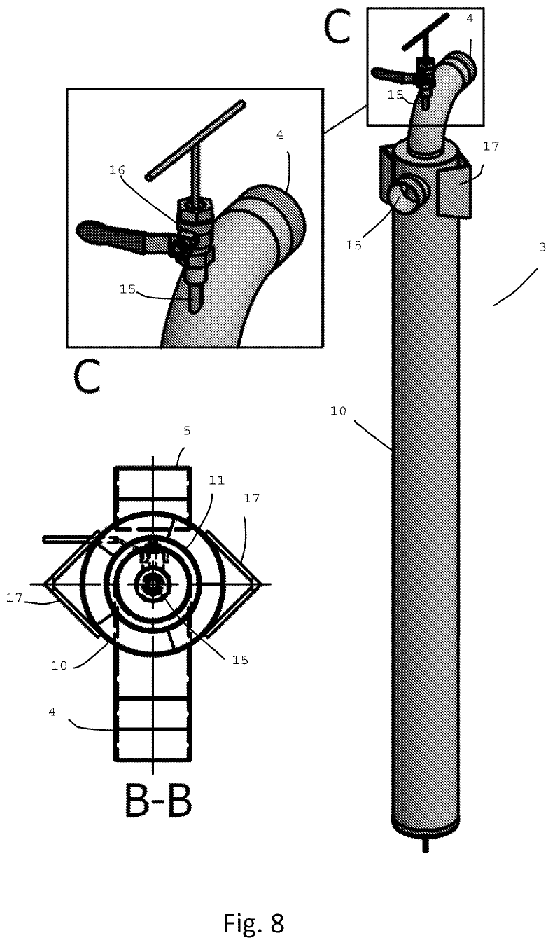

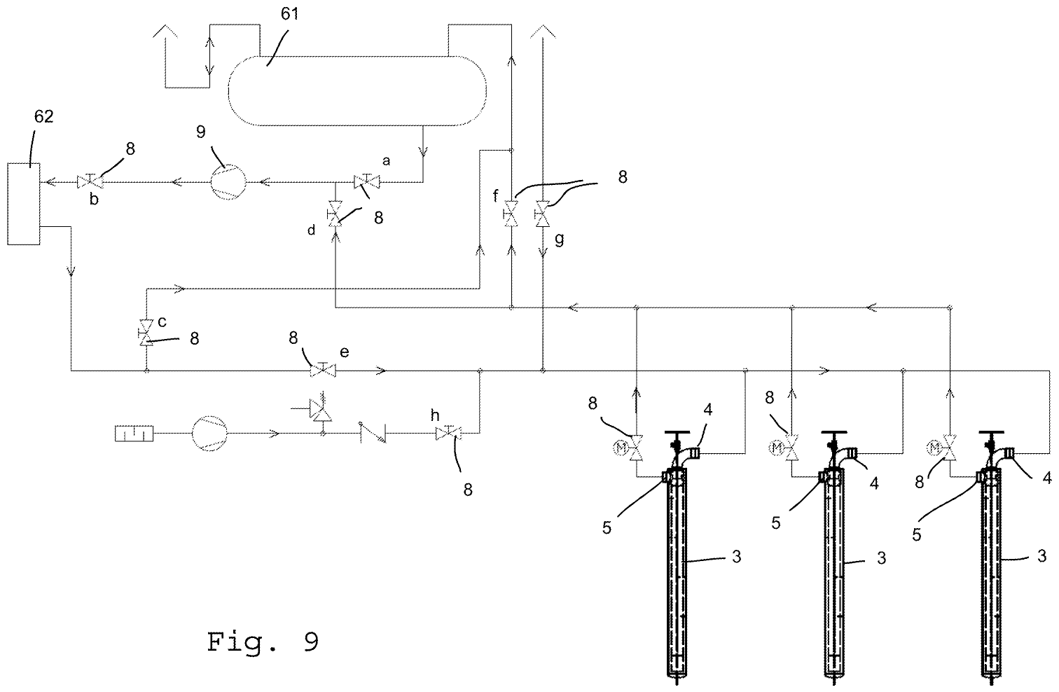

FIGS. 7 and 8 show an alternative embodiment of the cooling lance. In this embodiment, the extraction aeration pipe 15 is provided running within the coolant outer mantle 10. In particular, it runs though the coolant lance inner tube 11. Specifically, the extraction aeration pipe 15 runs in this embodiment centrally and coaxially in the cooling lance 3. The coolant outer mantle and the coolant lance inner tube 11 are coaxial. In this embodiment, the extraction aeration pipe 15 is also coaxial with the mantle 10 and inner tube 11. This makes the cooling lance more robust. It also ensures easier removal and insertion.

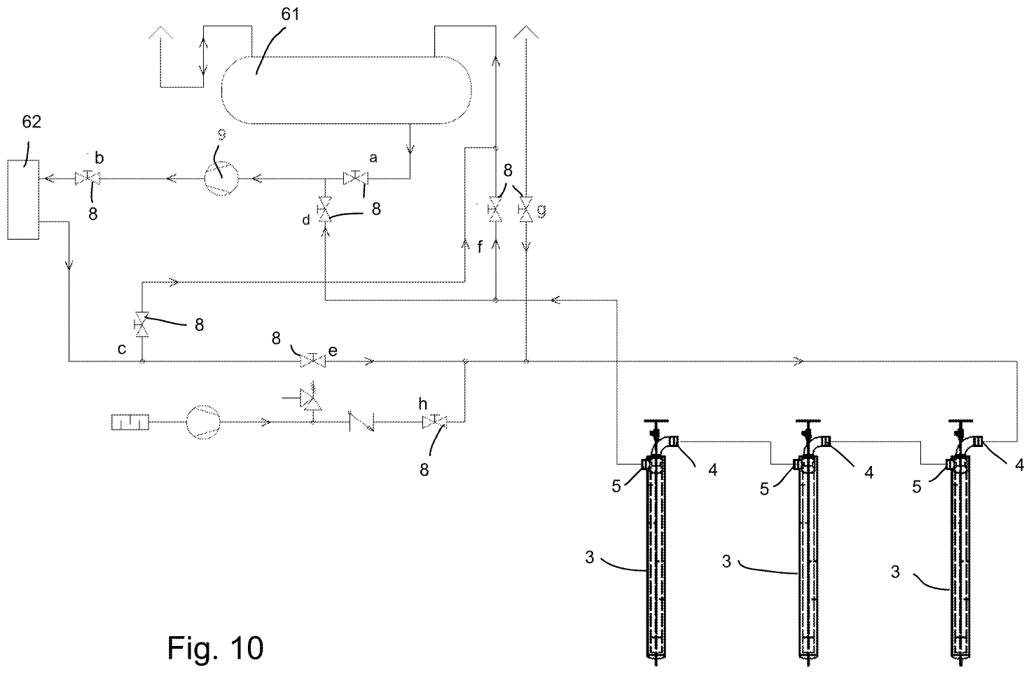

FIGS. 9 and 10 show schematic views of the assembly in an alternative embodiment. FIG. 9 shows the cooling lances 3 in parallel coupling, and FIG. 10 in serial coupling. In use, the control, cooling and other equipment will be provided in a separate, closed container. The drawings do not show the coupling to the controller like FIG. 1, but the coupling and controller are present. The drawings show the coolant system layout.

The operation of the embodiment of FIGS. 9 and 10 has three steps (specific valves indicated with letters, non-mentioned valves closed):
Freeze: Valves a-b-e-f open
Emptying lances: Valves d-b-c-g open
Defrost/blower: Valves h-f open

In the embodiments of FIGS. 9 and 10, a buffer vessel for the coolant is used. It allows more continuous operation, and a lower peak power consumption. Furthermore, a plate heat exchanger 62 is included.

The controller in an embodiment illustrated comprises a data processor and a computer program comprising a non-transitory computer readable medium. When running om said data processor, said computer program receives or retrieves temperature data from said at least one temperature sensor. The computer program can compare the temperature data with set temperature data for said temperature sensor. Furthermore, the computer program can control a flow rate of said coolant through said cooling lance for reaching and maintaining said set temperature.

A method for exterminating weeds or plants can be described as follows.

The plants above the surface of the surface are carefully removed. Care should be taken not to remove parts of plants and seeds from the location. Thus, care should be taken that no parts are displaces in for instance grooves and profile of threads of wheels and in boots and shoes. Removed material is put on a heap and a box wall is placed about an area to be processed and also enclosing the heap of removed material.

A box wall is placed around the area or part of land where the weed control procedure is worked. The box wall fences of a processing area. The box wall is about 20-50 cm high and from an insulating material. The box wall may comprises on or more passages for conduits 6, 7. Furthermore, the box can be provided with air circulation means, for instance ventilators. The box wall can be placed before or after removal of plant material that is above the surface. For easy working, the removed material can be put inside the area enclosed by the box wall.

In case of a uneven surface, for instance, in stead of the box, another insulation measure can be taken. For instance, an insulation blanket can be used to cover an area that is provided with cooling lances. In an embodiment, one side of the insulation blanket is provided with coolant conduits. In this way, the surface of the area where the cooling lances are inserted can be cooled additionally. The cooling blanket can at the side opposite of the cooling conduits be provided with heat-reflecting material to reflect heat away from the ground surface.

Based upon the ground condition (clay, sand, loss, . . . ) and humidity of the ground (for instance at various depths) a mutual distance and pattern of the cooling lances is determined and/or calculated. This may be calculated by the assembly controller, for instance. As an example, for “average” ground conditions, the freezing of ground may grow about 25 cm. Usually, the holes are made in a pattern such the three proximate holes are tips of a triangle with equal length sides.

Holes are made in the ground for insertion of the coolant lances. Often, a diameter of these holes is about 5-20% larger than the diameter of the lances. The holes can be made using known methods and equipment, like an auger. Ground removed is placed within the area enclosed by the bow wall. Usually, roots will still be present. Within the region of treatment, using for instance an auger that is driven by an actuator or that is hand driven or other means for drilling a hole in the ground, like a vibrational ground drill, holes are made. The holes in general have a depth that is dictated by the length of the cooling lances.

The cooling lances are inserted into the holes, and temperature sensors, for instance temperature lances, are also inserted in a predetermined pattern. For instance, at corners of near the box wall.

Possible remaining space between hole walls and the coolant lances/temperature lances can be filed with sand/ground and/or water.

Next, flexible conduits are attached to the coolant lances, and coupled to the cooling device. The temperature lances and other temperature sensors and valves are coupled to the controller. Often, if possible, wireless data coupling is used.

The controller now starts the cooling device so as to start circulation of coolant.

Switch on the cooling system allows coolant to circulate through the lances. This will cool and eventually freeze the soil or ground. This may take several days to several weeks. In this time, the soil will be cooled to a temperature of below 263K and often even lower. For most weeds, cooling to a temperature of 240K is sufficient. During the procedure, the controller can keep logging data, like temperature date. In this way, a temperature profile in time of the treated area is logged, providing a data set providing a certification basis and an effect control measurement.

After some predetermined treatment time, the cooling device is stopped and the flexible conduits are disengaged from the cooling lances.

In a next step, the coolant is pumped out of the lances and can be retrieved for re-use. After the coolant is removed, usually the cooling lances are frozen into the ground. For removing the cooling lances, first the coolant inlet or coolant outlet is coupled to a hot air generator. This blows hot air through each of the lances.

In a next step, the lances can be removed.

In an embodiment, a specially designed extraction device can be used. An extraction force is applied to a lance, directed in a direction for pulling the lance out of the ground. In fact, in an embodiment the extraction force is applied on the lance while it is still frozen into the ground. Once the extraction force is applied, the hot air is blown through the lance. In fact, other heating means can also be applied, like for instance a heating spiral in or on the mantle or a lance.

It will also be clear that the above description and drawings are included to illustrate some embodiments of the invention, and not to limit the scope of protection. Starting from this disclosure, many more embodiments will be evident to a skilled person. These embodiments are within the scope of protection and the essence of this invention and are obvious combinations of prior art techniques and the disclosure of this patent.

### REFERENCE NUMBERS

1 assembly
2 cooling device
3 cooling lance
4 coolant inlet
5 coolant outlet
6 flexible inlet conduit
7 flexible outlet conduit
8 coolant valve
9 coolant pump
10 coolant lance outer mantle
11 coolant lance inner tube
12 tip end
13 coupling end
14 tip coolant flow end
15 extraction aeration pipe
16 aeration pipe lever
17 extraction handle
18 coolant lance centering part
19 lance temperature sensor
20 insulation box
21 box wall
22 box lid
25 controller
26 wireless transmitter
27 data processor
28 coolant pump
30 extraction device
31 pre-tension device
32 extraction line
33 tension indicator
34 tensioning device
40 temperature probe/temperature lance
41 Wireless transmitter for temperature probe
42 container
43 residual coolant
44 emptying device exit
45 emptying device pump
46 emptying device conduit
50 heater/hot air heater
60 emptying device
61 Buffer tank
10 62 plate heat exchanger
D maximum lance distance
T temperature sensor

1. An assembly for exterminating a plant or weed comprising:
a cooling device for cooling a coolant, and
a cooling lance, fluidly coupled to said cooling device via at least one flexible conduit, said cooling lance adapted to be inserted into the ground and said flexible conduit allowing said cooling lance to be inserted into said ground at a freely selectable position from said cooling device, said cooling lance further comprising:
a length of 0.5-2 meters;
a tip end for inserting and lowering into the ground;
a coupling end opposite said tip and having a coolant inlet and a coolant outlet for said coolant, and
a coolant flow path through said cooling lance and coupling said coolant inlet and said coolant outlet and allowing cooling of at least part of said cooling lance, with said coolant inlet of said cooling lance fluidly coupled to a coolant outlet of said cooling device and said coolant outlet of said cooling lance fluidly coupled to said coolant inlet of the cooling device for circulating said coolant.

2. The assembly according to claim 1, wherein said at least one flexible conduit comprises a flexible supply conduit and a flexible return conduit, said flexible supply conduit coupled to said coolant inlet of said cooling lance, and said flexible return conduit coupled to said coolant outlet of said cooling lance.

3. The assembly according to claim 1, wherein said cooling lance comprises a substantially tubular outer mantle ending at one end in said tip end suitable for driving said cooling lance into ground, an inner tube having one end coupled to a flexible conduit and its opposite end extending within said outer mantle to said tip end of said outer mantle.

4. The assembly of claim 1, comprising a series of said cooling lances, each cooling lance coupled to said cooling device via said at least one flexible conduit allowing each cooling lance to be positioned individually into the ground, each of said cooling lances comprising at least one flexible conduit.

5. The assembly of claim 4, wherein each of said cooling lances comprises said flexible conduit, such that said cooling lances are fluidly coupled in parallel to said cooling device, each cooling lance comprising a flexible inlet conduit fluidly coupled to a cooling device outlet and a flexible outlet conduit fluidly coupled to a cooling device inlet.

6. The assembly of claim 1, further comprising a reservoir for coolant, fluidly coupled to said cooling device.

7. The assembly according to claim 1, further comprising a temperature lance for inserting into the ground, said temperature lance comprising at least one temperature sensor.

8. The assembly according to claim 7, further comprising a controller, at least one temperature lance functionally coupled to said controller, and said cooling device functionally coupled to said controller, wherein said controller is adapted for in operation operating said cooling device to a set temperature of said temperature sensor.

9. The assembly of claim 8, wherein said controller comprises a data processor and a computer program comprising a non-transitory computer readable medium, wherein when running on said data processor, receives temperature data from said at least one temperature sensor, compares said temperature data with set temperature data for said temperature sensor, and controls a flow rate of said coolant through said cooling lance for reaching and maintaining said set temperature.

10. The assembly according to claim 1, further comprising an insulation box comprising a box wall and a box lid, said box wall providing a closed wall enclosing in use a processing area including said at least one cooling lance, and said box lid resting on said box wall.

11. A method for exterminating weeds and plants, comprising:
cooling said coolant to a temperature of below 258K, using a coolant that is liquid in at least a temperature range of 173K-260K;
inserting a said cooling lance with its tip end into ground near a said weed or plant for defining an area to be processed;
circulating said coolant through said cooling lance for attaching an extermination temperature of below 258K, and
maintaining said extermination temperature of said cooling lance for a predefined amount of time.

12. The method of claim 11, further comprising
placing a box wall for enclosing an area to be processed, and
applying a box lid on said box wall.

13. The method of claim 11, comprising:
providing a temperature sensor in a temperature lance, at a predefined distance of said cooling lance, and circulating said coolant until said temperature sensor indicates a set temperature for said temperature sensor for the predefined amount of time.

14. A cooling lance for insertion into the ground, said cooling lance:
having a length of 0.3-2 meters;
and comprising:
a tip end for inserting and lowering into the ground;
a coupling end opposite said tip and having a coolant inlet and a coolant outlet for said coolant;
a coolant flow path through said cooling lance and coupling said coolant inlet and said coolant outlet and allowing cooling of at least part of said cooling lance, and
an extraction aeration pipe extending from said coupling end to said tip end and extending in cooling lance inner tube, said extraction aeration pipe extending coaxially cooling lance inner tube in said inner tube.

15. The cooling lance of claim 14, comprising an outer mantle, a cooling lance inner tube, wherein said cooling lance inner tube extends coaxially in said outer mantle, said cooling lance inner tube comprising said coolant inlet and outer mantle comprising said coolant outlet.

16. The cooling lance of claim 15, wherein said coolant lance inner tube extends in said outer mantle to between 1 and 20 cm from said tip end.

17. (canceled)

18. The method of claim 11 wherein the predefined amount of time is least 5 days.
